(19) United States
(12) Patent Application Publication
(10) Pub. No.: US 2026/0088391 A1
(43) Pub. Date: Mar. 26, 2026

(54) BATTERY MODULE AND ASSEMBLY METHOD THEREOF, AND POWER BATTERY

(71) Applicant: SinoEV (Hefei) Powertrain Technology Co., Ltd, Hefei (CN)

(72) Inventors: Xingliang WANG, Hefei (CN); Dongsheng HU, Hefei (CN); Delian LI, Hefei (CN); Peng ZHOU, Hefei (CN)

(73) Assignee: SinoEV (Hefei) Powertrain Technology Co., Ltd, Hefei (CN)

(21) Appl. No.: 18/896,912

(22) Filed: Sep. 26, 2024

(51) Int. Cl. H01M 10/6555; H01M 10/615; H01M 10/6571; H01M 50/233; H01M 50/264; H01M 50/483; H01M 50/519

(52) U.S. Cl. CPC H01M 10/6555; H01M 10/615; H01M 10/6571; H01M 50/233; H01M 50/264; H01M 50/483; H01M 50/519

(57) ABSTRACT

The embodiments of the present disclosure provide a battery module and an assembly method thereof, and a power battery. The battery module includes at least two battery cell groups arranged in parallel within the module housing. At two end surfaces of the battery cell groups arranged in parallel, the battery cell groups are pressed and fixed by a front-end plate and a rear-end plate. A T-shaped heating plate is arranged between two adjacent battery cell groups. A body portion of the T-shaped heating plate extends from top to bottom between the two battery cell groups. Two arms of the T-shaped heating plate extend to shoulder portions of the two battery cell groups, respectively, and electrical components are assembled on a top portion and are closed and fixed on a top portion of the module housing by means of an upper cover plate.

### TECHNICAL FIELD

The present disclosure relates to the new energy field, and particularly to a battery module and an assembly method thereof, and a power battery.

### BACKGROUND ART

With the rapid development and application of the new energy field in recent years, in the field of electric passenger cars, and engineering machinery, such as excavators and other specific applications, new energy power batteries as the main driving force is being vigorously promoted.

On this basis, the market has increasingly high demands for the compactness of the structural dimensions, and the improvement of energy density and the endurance capacity of power batteries. Moreover, to be flexibly applicable to various specific application scenarios, it is also required that the power batteries can be more conveniently modularly integrated and assembled to adapt to various specific application scenarios and cooperate with multiple product models.

### SUMMARY

The embodiments of the present disclosure provide a battery module, including: a module housing with an open top and at least two battery cell groups arranged in the module housing. The battery cell groups are arranged in parallel with each other, and at two end surfaces of the battery cell groups arranged in parallel, the battery cell groups are pressed and fixed in the module housing by a front-end plate and a rear-end plate. Each battery cell group includes multiple monomer battery cells in an arrangement. A T-shaped heating plate is arranged between two adjacent battery cell groups. A body portion of the T-shaped heating plate extends from top to bottom between the two battery cell groups. Two arms of the T-shaped heating plate extend to shoulder portions of the two battery cell groups, respectively, and electrical components are assembled on top portions of at least two battery cell groups and are closed and fixed on a top portion of the module housing by means of an upper cover plate.

The embodiments of the present disclosure also provide a power battery, including one or more groups of battery modules.

The embodiments of the present disclosure also provide a assembly method of a battery module, including: providing a module housing with an open top; arranging the rear-end plate into the module housing, arranging at least two battery cell groups in parallel into the module housing through the open top, with one end surface of the at least two battery cell groups fitting against the rear-end plate, wherein the battery cell groups include multiple monomer battery cells in an arrangement; inserting a front-end plate between the other end surface of the at least two battery cell groups and the module housing, to press and fix the at least two battery cell groups in the module housing along an arrangement direction of the monomer battery cells of the battery cell groups; arranging a T-shaped heating plate between the two adjacent battery cell groups, with a body portion of the T-shaped heating plate extending from the top to the bottom between the two battery cell groups, until two arms of the T-shaped heating plate are respectively snapped to shoulder portions of the two battery cell groups; arranging a fixing strip on an outer shoulder portion of the battery cell group located on a side of the module housing, wherein the fixing strip is of an L-shaped structure; inserting one arm of the fixing strip along an outer side edge of the battery cell group between the outer side edge of the battery cell group and the side of the module housing, until the other arm of the fixing strip abuts the shoulder portion of the battery cell group and is fixed with structural adhesive; and assembling electrical components at a top portion of the battery cell group that is arranged with the T-shaped heating plate and the fixing strip and covering an upper cover plate, so as to fix the battery cell groups in a vertical direction within the module housing, and closing the top portion of the module housing.

### BRIEF DESCRIPTION OF DRAWINGS

In order to more clearly illustrate the technical solutions of the embodiments of the present disclosure, the following will briefly introduce the drawings used in the embodiments. It should be understood that the following drawings only show some embodiments of the present disclosure, and therefore it should not be regarded as a limitation on the scope. Those ordinary skilled in the art can also obtain other related drawings based on these drawings without inventive effort.

FIG. 1 is a structural schematic view of a battery module provided in the embodiments;

FIG. 2 is an exploded schematic view of a battery module provided in the embodiments;

FIG. 3 is a structural schematic view of a battery module provided in a first perspective view in the embodiments;

FIG. 4 is a structural schematic view of a battery module provided in a second perspective view in the embodiments;

FIG. 5 is an exploded schematic view of a T-shaped heating plate in a battery module provided in the embodiments;

FIG. 6 is a structural schematic view of a power battery provided in the embodiments;

FIG. 7 is a flowchart of an assembly method of a battery module provided in the embodiments;

FIG. 8 is another flowchart of an assembly method of a battery module provided in the embodiments; and

FIG. 9 is another flowchart of an assembly method of a battery module provided in the embodiments.

Reference numerals: 100—battery module; 110—module housing; 111—bottom plate; 112—side plate; 120—battery cell group; 121—monomer battery cell; 122—foam; 130—front-end plate; 140—rear-end plate; 150—T-shaped heating plate; 151—body portion; 1511—body housing; 1512—body cover plate; 1513—heating wire; 152—arm; 153—extension fixing part; 160—electrical component; 161—mica plate; 162—flexible printed circuit; 163—high-voltage connection structure; 164—microcontroller unit; 170—upper cover plate; 180—fixing strip; 191—bottom insulation plate; 192—side insulation plate; 193—end insulation plate.

### DETAILED DESCRIPTION OF EMBODIMENTS

To make the objectives, technical solutions, and advantages of the embodiments of the present disclosure clearer, the technical solutions in the embodiments of the present disclosure will be described clearly and completely below in conjunction with the drawings of the embodiments of the present disclosure. Obviously, the described embodiments are a part of the embodiments of the present disclosure. The detailed description of the embodiments is not intended to limit the scope of the claims of the present disclosure but merely illustrates selected embodiments of the present disclosure. The components of the embodiments of the present disclosure described and shown in the drawings herein can generally be arranged and designed in various configurations. All other embodiments obtained by those of ordinary skill in the art without making inventive efforts are within the scope of protection of the present disclosure.

It should be noted that similar numerals and letters denote similar terms in the following drawings so that once an item is defined in one drawing, it does not need to be further discussed in subsequent drawings.

In the description of the present disclosure, it should be noted that the terms “up”, “down”, “inner”, “outer”, and similar directional or positional terms are based on the orientation or positional relationship shown in the drawings, or they represent the customary orientation or positional relationship when the disclosed product is used. These terms are used solely for the purpose of describing the present disclosure and simplifying the description, and do not indicate or imply that the device or component referred to must have a specific orientation, be constructed and operated in a particular orientation. Therefore, they should not be understood as limiting the scope of the present disclosure.

In addition, the terms, such as “first” and “second”, are only used to distinguish the descriptive and are not to be construed as indicating or implying relative importance. It should be noted that the features in the embodiments of the present disclosure can be combined with each other without conflict.

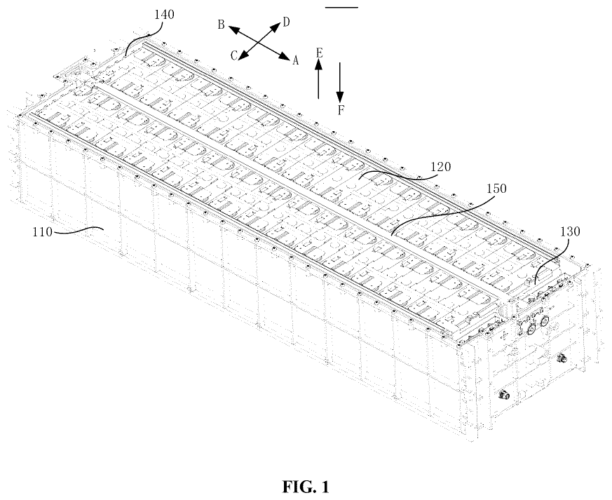

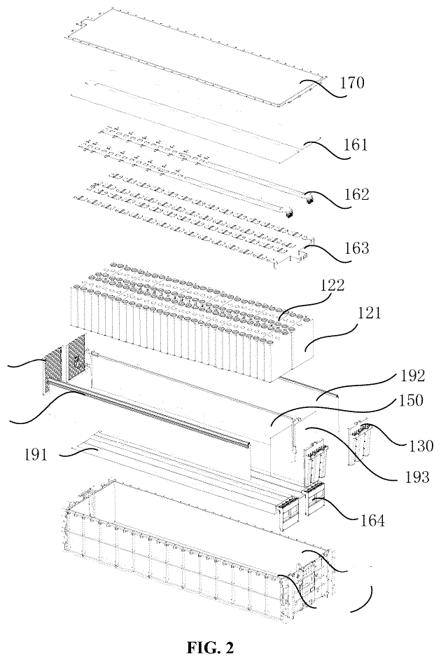

Referring to FIGS. 1 to 2, the embodiment provides a battery module 100, a power battery 200, and an assembly method of the battery module 100. The power battery 200 assembled by using the battery module 100 can be used in a variety of small, medium, and large devices in multiple fields such as automobiles, engineering equipment, and energy storage devices.

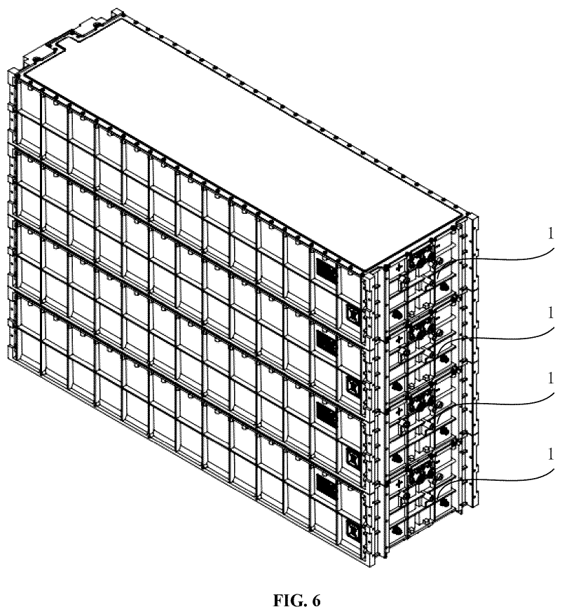

FIGS. 1 to 5 are various structural schematic views of a battery module 100 provided in the embodiment. FIG. 6 is a structural schematic view of a power battery 200 provided in the embodiments. FIGS. 7 to 9 are flowcharts of an assembly method of a battery module 100 provided in the embodiments.

A, B, C, D, E, and F directional arrows are shown in FIG. 1 for correspondingly indicating the spatial orientation and spatial positional relationship of the product in FIG. 1. For ease of understanding, the directions shown are first explained and illustrated separately in the following, with the aim of making it convenient for a person skilled in the art to understand the relative positional relationship of the components in the battery module 100 and the compositional relationship of the power battery 200 comprising the battery module 100 by means of the explanatory illustrations in relation to the drawings. However, it should not be understood that the battery module 100 in the embodiment is only capable of having the spatial orientation and spatial location relationship as shown in FIG. 1. When the product converts its spatial position, the directions indicated by the A, B, C, D, E, and F directional arrows shown in FIG. 1 no longer satisfy the schematic representation of the product in the new spatial position, and the corresponding adjustments and definitions should be made anew.

The battery module 100 is illustrated in FIG. 1. Based on a current state that the battery module 100 is in, A, B, C, D, E, and F directional arrows are defined as follows.
Direction A can be understood as the forward direction. In the following text, when descriptions mention “the front end of a component” or “in front of a component,” it should be understood in conjunction with FIG. 1 that this refers to the end portion of the component along the direction A or the region in front of the component along the direction A.
Direction B can be understood as the rear direction. In the following text, when descriptions mention “the rear end of a component” or “behind a component,” it should be understood in conjunction with FIG. 1 that this refers to the end portion of the component along the direction B or the region behind the component along the direction B.
Direction C can be understood as the left direction. In the following text, when descriptions mention “the left end of a component” or “the left side of a component,” it should be understood in conjunction with FIG. 1 that this refers to the end portion of the component along the direction C or the region to the left of the component along the direction C.
Direction D can be understood as the right direction. In the following text, when descriptions mention “the right end of a component” or “the right side of a component,” it should be understood in conjunction with FIG. 1 that this refers to the end portion of the component along the direction D or the region to the right of the component along the direction D.
Direction E can be understood as upward or referred to as the top direction. In the following text, when descriptions mention “the upper end of a component,” “the top of a component,” or “the top portion of a component,” it should be understood in conjunction with FIG. 1 that this refers to the end portion of the component along the direction E or the region above the component along the direction E.
Direction F can be understood as downward or referred to as the bottom direction. In the following text, when descriptions mention “the lower end of a component,” “the bottom portion of a component,” “the bottom end of a component,” or “the bottom surface of a component,” it should be understood that this refers to the end portion of the component along the direction F or the region below the component along the direction F.

Referencing FIG. 1 and FIG. 2, the battery module 100 provided in the embodiments of the present disclosure includes a module housing 110 with an open top and at least two battery cell groups 120 arranged within the module housing 110. The battery cell groups 120 are arranged in parallel, and at two end surfaces of the battery cell groups 120 arranged in parallel, the battery cell groups 120 are pressed and fixed within the module housing 110 by a front-end plate 130 and a rear-end plate 140. Each battery cell group 120 includes multiple monomer battery cells 121 in an arrangement. A T-shaped heating plate 150 is arranged between two adjacent battery cell groups 120. A body portion 151 of the T-shaped heating plate 150 extends from top to bottom between the two battery cell groups 120. Two arms 152 of the T-shaped heating plate 150 extend to shoulder portions of the two battery cell groups 120, respectively, and electrical components 160 are assembled on top portions of at least two battery cell groups 120 and are closed and fixed on a top portion of the module housing 110 by means of an upper cover plate 170.

As shown in FIG. 2, the battery cell groups 120 are arranged in parallel within the module housing 110. Multiple battery cell groups 120 can be arranged in the module housing 110 as needed, for example, three groups arranged in parallel, or four groups arranged in parallel. FIG. 2 illustrates an embodiment where two battery cell groups 120 are arranged in parallel within the module housing 110. The following descriptions and illustrations use the example of the two battery cell groups 120 arranged in parallel within the module housing 110. When employing a specific embodiment with multiple battery cell groups 120 arranged within the module housing 110, all battery cell groups 120 are arranged in parallel within the module housing 110.

The battery cell groups 120 are arranged in parallel between the front-end plate 130 and the rear-end plate 140 and are pressed and fixed by the module housing 110, the front-end plate 130, and the rear-end plate 140. Exemplarily, in general, to ensure that the parallel-arranged battery cell groups 120 can be stably pressed and fixed, the lengths of the parallel-arranged battery cell groups 120 between the front-end plate 130 and the rear-end plate 140 are usually set to be equal or approximately equal. This avoids the situation where, if the battery cell groups 120 are of different lengths, the longer battery cell groups 120 are already pressed and fixed between the front-end plate 130 and the rear-end plate 140, but the two end surfaces of the shorter battery cell groups 120 cannot simultaneously contact both the front-end plate 130 and the rear-end plate 140.

For each group of battery cell groups 120, each battery cell group 120 includes multiple monomer battery cells 121 in arrangement. The arrangement direction of the monomer battery cells 121 is a direction along the rear-end plate 140 towards the front-end plate 130. After the monomer battery cells 121 are arranged to form the battery cell group 120, the battery cell group 120 is subjected to a pressing force to realize pressing and fixation between the rear-end plate 140 and the front-end plate 130. Therefore, in the following explanations of the present disclosure, the surface of the monomer battery cell 121 in this direction is referred to as a pressing surface, indicating that the monomer battery cell 121 bears the pressing force on the pressing surface, and the surfaces of the monomer battery cell 121 in other directions are referred to as side surfaces.

A T-shaped heating plate 150 is arranged between two adjacent battery cell groups 120. As shown in FIG. 2, the T-shaped heating plate 150 includes a body portion 151 and two arms 152 connected perpendicularly to one end of the body portion 151, and the body portion 151 and the two arms 152 together form the T-shaped structure of the T-shaped heating plate 150. Since the battery cell group 120 needs to maintain a certain operating temperature, especially before operation, it is often necessary to heat the monomer battery cells 121 to a sufficient temperature to ensure stable operation. The battery cell groups 120 are composed of multiple tightly arranged monomer battery cells 121. Therefore, in the solution of the present disclosure, the body portion 151 of the T-shaped heating plate 150 extends from top to bottom between the two battery cell groups 120. The two arms 152 of the T-shaped heating plate 150 extend to the shoulder portions of the two battery cell groups 120, respectively. In this way, the heat generated by the body portion 151 of the T-shaped heating plate 150 can be evenly transferred to each monomer battery cell 121 in the two battery cell groups 120. The arms 152 of the T-shaped heating plate 150 extend and are located on the shoulder portions of the battery cell groups 120, which can also fix the T-shaped heating plate 150 and the battery cell groups 120 to each other in the left-right direction as shown in FIG. 1 and press the battery cell groups 120 downward into the module housing 110.

Additionally, the body portion 151 of the T-shaped heating plate 150 is inserted between the two battery cell groups 120, and the arms 152 of the T-shaped heating plate 150 are loaded on the shoulders of the battery cell groups 120. The T-shaped heating plate 150 and the two battery cell groups 120 are also fixed together using structural adhesive.

After fixing the T-shaped heating plate 150 to the battery cell groups 120, the electrical components 160 are assembled on top portions of at least the two battery cell groups 120 and then closed and fixed at the top portion of the module housing 110 with an upper cover plate 170, and the battery cell groups 120 are stably fixed within the module housing 110. The electrical components 160 are assembled to multiple monomer battery cells 121 within at least the two battery cell groups 120, configured for power and communication. The electrical components 160 are provided with connection ports that extend out of the module housing 110 and are configured for power and communication with the outside.

The battery module 100 provided in the embodiments of the present disclosure includes a module housing 110 with an open top and at least two battery cell groups 120 arranged within the module housing 110. The battery cell groups 120 are arranged in parallel, and at two end surfaces of the battery cell groups 120 arranged in parallel, the battery cell groups 120 are pressed and fixed within the module housing 110 by a front-end plate 130 and a rear-end plate 140, thereby pressing and fixing at least two battery cell groups 120 in the front-rear direction. Each battery cell group 120 includes multiple monomer battery cells 121 in an arrangement. In the pressed and fixed state, the relative positional relationships of the multiple monomer battery cells 121 are compact and stable. A T-shaped heating plate 150 is arranged between the adjacent battery cell groups 120. The body portion 151 of the T-shaped heating plate 150 extends from top to bottom between the two battery cell groups 120. The two arms 152 of the T-shaped heating plate 150 extend to the shoulder portions of the two battery cell groups 120. In this way, on one hand, this allows the body portion 151 of the T-shaped heating plate 150 to uniformly conduct heat to each monomer battery cell 121 in the two battery cell groups 120. On the other hand, it is also capable of fixing the shoulder portions of the two battery cell groups 120 by the two arms 152 of the T-shaped heating plate 150, respectively, to press the battery cell groups 120 against the bottom of the module housing 110, and to avoid movement or collision between the T-shaped heating plate 150 and the battery cell groups 120 in the left-right direction. At the top portions of at least two battery cell groups 120, the electrical components 160 are assembled, and enclosed and fixed at the top of the module housing 110 with an upper cover plate 170. After connecting the battery cell groups 120 for power and communication, the battery cell groups 120 are fixed within the module housing 110 in the up-down direction. The battery module 100 provided in the present disclosure has a compact structure with stable internal components, where the internal components are stabilized and fixed to each other. The uniform heating by the T-shaped heating plate 150 ensures that the battery module 100 operates stably and efficiently, and the structure can be flexibly adapted to various application scenarios and specific spatial scopes.

Optionally, as shown in FIG. 2, the module housing 110 includes a rectangular bottom plate 111 and side plates 112 that are connected to the edges of the bottom plate 111 and extend vertically. The adjacent side plates 112 are fixedly connected to each other. The space enclosed by the bottom plate 111 and the side plates 112 is configured to accommodate and fix the at least two battery cell groups 120.

The rectangular structure of the module housing 110 efficiently integrates spatial structural relationships, thus ensuring a compact internal structure for the battery module 100 without wasted space. The space enclosed by the bottom plate 111 and the side plates 112 is cooperated to house the battery cell groups 120, and the bottom plate 111 and the side plates 112 are inherently capable of constraining the position of the battery cell groups 120 provided in the space. Moreover, combined with other detailed fixing structures and applied pressing forces, the battery cell groups 120 are effectively fixed in all directions within the module housing 110.

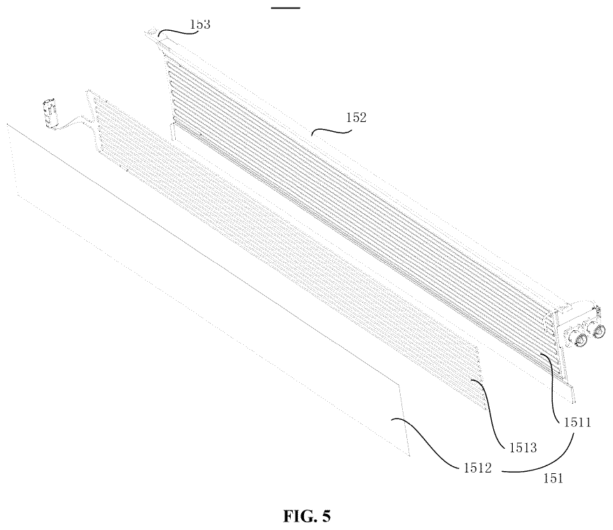

Optionally, as shown in FIG. 5, the T-shaped heating plate 150 includes a body portion 151 and two arms 152 connected to one end of the body portion 151. The body portion 151 includes a body housing 1511 and a body cover plate 1512, which are capped with each other, and a heating wire 1513 arranged inside the body housing 1511 in a coiled manner. The heating wire 1513 is led out through the end portion of the body housing 1511, and is configured for power heating to ensure that the body portion 151 heats evenly.

For example, still referring to FIG. 5, a holding groove is machined at the bottom of the body housing 1511, wherein the holding groove has a semi-circular section and is configured for housing the heating wire 1513. The structural adhesive is filled between the body housing 1511 containing the heating wire 1513 and the body cover plate 1512.

In this way, when assembling the T-shaped heating plate 150, first, the bottom of the body housing 1511 is machined with a holding groove, and the section of the holding groove is semicircular. Typically, the heating wire 1513 is a metal wire with a round section. Placing the heating wire 1513 into the holding groove can allow the heating wire 1513 to be completely contained within the holding groove. After filling the gaps in the holding groove with structural adhesive, the body cover plate 1512 is tightly sealed. The internal space of the body portion 151 is fully utilized, and the filling of the structural adhesive is able to prevent the heating wire 1513 from shaking or colliding between the inner walls of the holding groove due to gaps, while effectively ensuring heat conductivity efficiency.

It is to be noted that the embodiments of the present disclosure and the schematic drawings of FIG. 5 present only one specific way of coiling the heating wire 1513 within the body housing 1511. In fact, it is not limited to this. How the heating wire 1513 is coiled within the body housing 1511 can be designed as desired, and the corresponding shape of the holding groove is pre-machined in the body housing 1511 according to the design so as to correspond to the arrangement of the heating wire 1513. One end of the heating wire 1513 leads out to a port and a plug-in configured for connecting to an external power source and activating or deactivating the heating based on control signals.

Optionally, as shown in FIG. 5, the T-shaped heating plate 150 also includes extension fixing parts 153 at both ends. The extension fixing parts 153 are located on the arms 152 of the T-shaped heating plate 150. On the extension fixing parts 153, the T-shaped heating plate 150 is fixedly connected to both ends of the module housing 110 via bolts.

The extension fixing parts 153 extend from two end portions of the arms 152, with threaded holes machined on the extension fixing parts 153. The bolts pass through the threaded holes in the extension fixing part 153, and after the T-shaped heating plate 150 is inserted between the two battery cell groups 120 and the arms are pressed against the shoulder portions of the battery cell groups 120, the T-shaped heating plate 150 is connected to the module housing 110 by bolts. In other words, the battery cell groups 120 are pressed into the module housing 110 by the force applied to the shoulder portions of the battery cell group 120 to avoid positional movement.

Optionally, as shown in FIGS. 2 and 3, the outer shoulder portions of the battery cell groups 120 located at the edges of the at least two parallel-arranged battery cell groups 120 are provided with fixing strips 180.

By arranging the T-shaped heating plate 150 between the two battery cell groups 120, the space between the two battery cell groups 120 is filled, thus enabling uniform heating of each monomer battery cell 121 of the two battery cell groups 120. Moreover, it is possible to press and fix the two battery cell groups 120 by the shoulder portions. Additionally, the outer shoulder portions of the battery cell groups 120 located at the edges are also provided with fixing strips 180. The fixing strips press onto the outer shoulder portions of the edge battery cell group 120, which makes it possible to press and fix the edge battery cell group 120 on the outer side. Thus, when the battery module 100 includes two battery cell groups 120, the shoulder portions of the two battery cell groups 120 on the sides close to each other are pressed and fixed by the arms 152 of the T-shaped heating plate 150, and the outer shoulder portions of the two battery cell groups 120 are pressed by separately arranged fixing strips 180. This ensures balanced pressing force on the top portions of the two battery cell groups 120 so that the two battery cell groups 120 are stably pressed and fixed in the up-down direction.

Optionally, the fixing strips 180 are L-shaped fixing strips, with one arm of the L-shaped fixing strip extending along the shoulder portion of the battery cell group 120 and the other arm extending along the outer side edge of the battery cell group 120.

The fixing strips 180 are designed as L-shaped fixing strips, and the L-shaped fixing strips are arranged on the outer shoulder portions of the battery cell groups 120. One arm extends along the shoulder portion of the battery cell group 120, achieving the aforementioned pressing and fixing for the battery cell group 120 in the up-down direction. The other arm of the L-shaped fixing strip extends along the outer side edge of the battery cell group 120 and extends between the battery cell group 120 and the side plate 111 of the module housing 110, thus filling the gap between the battery cell group 120 and the side plate 111 of the module housing 110 in the left-right direction. By filling the structural adhesive between the fixing strip 180 and the battery cell group 120, the fixing strip 180 is bonded to the outer shoulder portion of the battery cell group 120, ensuring a fixed relationship. Additionally, if there are any gaps between the side plate 111 and the battery cell group 120, they can also be filled with structural adhesive.

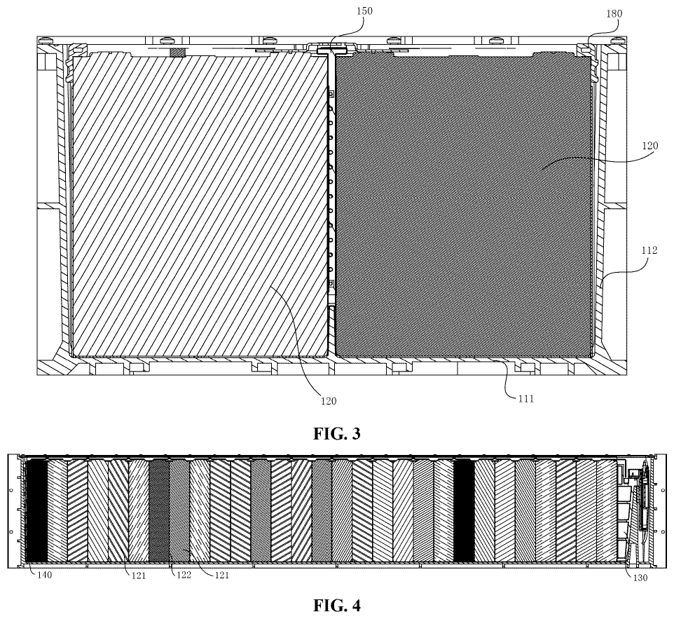

Optionally, as shown in FIG. 4, the battery cell group 120 includes multiple monomer battery cell 121, wherein the monomer battery cell 121 is provided with two opposite pressing surfaces and side surfaces between the two pressing surfaces. The pressing surfaces of multiple monomer battery cells 121 are opposite to each other, and foam 122 is sandwiched between the pressing surfaces of two adjacent monomer battery cells 121.

As illustrated in FIG. 4, the battery cell group 120 includes multiple monomer battery cells 121 in the arrangement. The opposite faces of the monomer battery cells 121 are pressing surfaces. After the battery cell group 120 is arranged in the battery module 100, the monomer battery cells 121 within the battery cell group 120 must endure a certain pressing force between the pressing surfaces to maintain fixed. Therefore, the foam 122 is sandwiched between two adjacent monomer battery cells 121 within the battery cell group 120.

During assembly, the fixed rear-end plate 140 is first arranged at one end inside the module housing 110, and then monomer battery cells 121 are arranged against the rear-end plate 140. For each arranged monomer battery cell 121, a piece of foam 122 is arranged, followed by arranging the next monomer battery cell 121 and another piece of foam 122, until the required number of monomer battery cells 121 has been arranged. Finally, the front-end plate 130 is arranged. The material properties of the foam 122 provide it with a certain compressive ability. Arranging foam 122 between two adjacent monomer battery cells 121 can be able to arrange the maximum number of monomer battery cells 121 as compactly as possible in the front-rear direction, which is the direction in which the battery cell groups 120 endure the pressing force. The compressive ability of the foam 122 can also absorb some of the pressing force in the front-rear direction, thereby protecting the monomer battery cells 121 in the battery cell group 120. This avoids excessive pressing force to harm the monomer battery cell 121, or friction or scratches between adjacent monomer battery cells 121.

Optionally, as shown in FIG. 4, the thickness of the front-end plate 130 gradually increases along the insertion direction toward the module housing 110, which is the F direction shown in FIG. 1. Therefore, after the battery cell groups 120 are assembled into the module housing 110, as the front-end plate 130 is inserted into the module housing 110, the pressing force of the front-end plate 130 on the pressing surfaces of the battery cell groups 120 gradually increases.

The section of the front-end plate 130 is wedge-shaped, and as it is inserted into the module housing 110 in the F direction, the thickness of the front-end plate 130 gradually increases. In other words, the thickness of the upper end of the front-end plate is greater than the thickness of the lower end. Thus, during assembly, the front-end plate 130, as the last component inserted in the front-rear direction, is easier to insert due to its wedge-shaped structure. Furthermore, with the design of the wedge-shaped structure, as the front-end plate 130 is gradually inserted deeper into the module housing 110, the thickness of the front-end plate 130 gradually increases, and the pressing force of the front-end plate 130 on the battery cell groups 120 increases until the front-end plate 130 is completely inserted into the module housing 110 to a predetermined position. This achieves the optimal transmission and maintenance of pressing force on the battery cell groups 120, and provides the preload force required for the monomer battery cell 121. The gradual insertion of the wedge-shaped front-end plate 130 also ensures that the pressing force is fully transmitted to each piece of foam 122 between two monomer battery cells 121 in the battery cell group 120. This fully utilizes the internal space of the module housing 110 and fully utilizes the compressive and protective functions of the foam 122.

Since the battery cell group 120 is located in the front-rear direction, the number of monomer battery cells 121 increases, and the entire battery cell group 120 may lack sufficient rigidity at the shoulder position, leading to issues such as some monomer battery cells 121 being expanded upwards. Therefore, on one hand, the arms 152 of the T-shaped heating plate 150 cover a shoulder portion on one side of all of the monomer battery cells 121 of the entire battery cell group 120. On the other hand, when fixing strips 180 are also provided, the fixing strips 180 contact and fix a shoulder portion on the other side of all of the monomer battery cells 121 of the entire battery cell group 120. In this way, the shoulder portions on both sides of the battery cell group 120 are pressed and fixed. At the same time, the T-shaped heating plate 150 and the fixing strips 180 are bonded and fixed to the battery cell groups 120 with structural adhesive.

Optionally, as shown in FIG. 2, a bottom insulation plate 191 is provided on the bottom plate 111 of the module housing 110, and side insulation plates 192 are respectively provided on the inner sides of the two opposite side plates 112 of the module housing 110. The side insulation plates 192 are located between the side surfaces of the battery cell groups 120 and the side plates 112 of the module housing 110. The end insulation plates 193 are provided between the front-end plate 130 and the pressing surfaces of the monomer battery cells 121 of the battery cell groups 120 which are arranged on the outside. The bottom insulation plate 191 is adhesively fixed to the bottom plate 111 of the module housing 110.

A bottom insulation plate 191 is provided at the bottom of the battery cell group 120. The bottom insulation plate 191 is fixed and bonded to the bottom plate 111 of the module housing 110 through structural adhesive, and structural adhesive is further applied on the bottom insulation plate 191 to bond and fix the battery cell groups 120 to the bottom insulation plate 191. Thereby, on the basis of realizing the insulating function at the bottom, the battery cell groups 120 are kept stably fixed with the bottom plate 111 of the module housing 110. On both sides in the left-right direction, side insulation plates 192 are also provided, respectively. The side insulation plates 192 are located between the outer side surfaces of the battery cell groups 120 and the side plates 112 of the module housing 110. Additionally, the top of the side insulation plate 192 abuts one arm of the L-shaped fixing strip 180. Structural adhesive fills the gaps around the side insulation plates 192, ensuring that the battery cell groups 120 are stably fixed in the left-right direction.

Optionally, as shown in FIG. 2, a mica plate 161 is provided between the electrical component 160 and the upper cover plate 170. The mica plate 161 has high insulation and heat resistance properties and is chemically stable, which is resistant to strong acids, strong alkalis, and pressure. The mica plate 161 is arranged to effectively insulate the heat and prevent thermal runaway of the battery cell group 120 during operation, thereby improving the safety of the battery module 100.

Optionally, the electrical component 160 includes a flexible printed circuit 162, a high-voltage connection structure 163, and a microcontroller unit 164. The flexible printed circuit 162 is electrically connected to the monomer battery cells 121 in at least two battery cell groups 120 via the high-voltage connection structure 163, with the high-voltage connection structure 163 leading out a total positive terminal and a total negative terminal which are configured for external power supply.

The flexible printed circuit (FPC for short) 162 possesses flexibility and bendability while maintaining the structural strength required to arrange and mount the high-voltage connection structure 163. A corresponding control circuit is formed on the flexible printed circuit 162. The flexible printed circuit 162 is electrically connected to monomer battery cells 121 in the at least two battery cell groups 120 via the high-voltage connection structure 163 and can be externally powered via the total positive terminal and the total negative terminal leading from the high-voltage connection structure 163. The microcontroller unit (MCU for short) 164 is an integrated electronic component that internally integrates a series of computer peripheral interface circuits, a processor, memory, and a clock circuit. The microcontroller unit 164 is arranged at the front end of at least two battery cell groups 120 and is electrically connected to the flexible printed circuit 162 and the high-voltage connection structure 163, which is configured for providing control, computation, and communication capabilities.

In summary, the battery module 100 provided by the present disclosure includes at least two battery cell groups 120 arranged in parallel within the module housing 110. Initially, a bottom insulation plate 191 is fixed and arranged on the bottom plate 111 of the module housing 110 using structural adhesive, and structural adhesive is applied to the bottom insulation plate 191 before arranging the battery cell groups 120.

Specifically, in the front-rear direction, a rear-end plate 140 is first arranged at the rear, against the rear-end plate 140. Multiple monomer battery cells 121 are inserted by alternately arranging one monomer battery cell 121 and one piece of foam 122 until the preset number of battery cell group 120 is reached. The front-end plate 130 is then inserted from the top to the bottom at the front end. As the front-end plate 130 is gradually inserted to reach the predetermined position, the structural adhesive enables the monomer battery cells 121 in the battery cell group 120 to have adhesive fixing force at the bottom. The pressing force provided by the pressing and insertion performed by the front-end plate 130 in the front-rear direction presses and fixes the monomer battery cells 121 in the battery cell groups 120. The foam 122 compresses under force to release a certain amount of space to ensure that the monomer battery cell 121 is compactly fixed within the space.

In the up-down direction, a T-shaped heating plate 150 is inserted between two adjacent battery cell groups 120. The body portion 151 of the T-shaped heating plate 150 can achieve even surface heating through heating wires 1513 that are uniformly wound. The remaining space between the T-shaped heating plate 150 and the battery cell group 120 is filled with structural adhesive, thus achieving the paste and fixation between the two. The two arms 152 of the T-shaped heating plate 150 are respectively placed on the shoulder portions of the two adjacent battery cell groups 120 on the sides close to each other, and are pasted and fixed. At the same time, the extension fixing part 153 extending from the arm 152 is also detachably connected to the module housing 110 by means of a threaded fastening connecting piece, thus fixing the shoulder portion of the battery cell group 120 on this side in the up-down direction.

In the left-right direction, the side insulation plates 192 are inserted between the side plate 112 on the left side of the module housing 110 and the battery cell group 120, and between the side plate 112 on the right side of the module housing 110 and the battery cell group 120, and the structural adhesive are filled for fix, so as to eliminate any potential spaces within the module housing 110 in the left-right direction. Next, fixing strips 180 are arranged on the outer shoulder portions of the battery cell group 120 located on the side, wherein the fixing strips cover the shoulder portions of all monomer battery cells 121 in the battery cell groups 120 on the side, and the fixing strips 180 can adopt an L-shaped structure. One arm of the L-shaped structure is placed on the shoulder portion of the battery cell group 120. The other arm extends between the side plate 112 of the module housing 110 and the battery cell group 120, and abuts the side insulation plate 192 or is opposite to the side insulation plate 192. Since the structural adhesive is filled between the fixing strip 180 and the battery cell group 120, and between the fixing strip 180 and the side plate 112 of the module housing 110, the remaining gap positions within the above space are sealed and fixed by filling with structural adhesive.

Returning to the up-down direction, after the front-rear direction and the left-right direction have been stabilized and fixed, the electrical component 160 is assembled on the top portion of the battery cell group 120. After arranging the mica plate 161, the upper cover plate 170 presses and covers the top portion of the module housing 110, and the upper cover plate 170 is fixedly connected to the module housing 110 in the up-down direction using threaded fastening connecting pieces, thus completing the closure and fixation of the battery module 100.

In conjunction with the above, the present embodiment also provides a power battery. The power battery includes one or more groups of the aforementioned battery modules 100.

As can be seen from the foregoing description, the battery module 100 provided by the present embodiment can accommodate an appropriate number of monomer battery cells 121 or battery cell groups 120 within the module housing 110, adapting to various application scenarios. The arrangement of the T-shaped heating plate 150 ensures uniform heating for the battery cell groups 120. Additionally, the battery module 100 provided by the embodiment of the present disclosure can achieve stable fixation of the battery cell groups 120 within the module housing 110 in the up-down direction, the left-right direction, and the front-rear direction.

On this basis, to further enable the power battery to flexibly adapt to various specific application scenarios, the present disclosure also provides a power battery. When the power battery includes multiple groups of battery modules 100, as an example, as shown in FIG. 6, a power battery comprising four groups of battery modules 100 is illustrated. The four groups of battery modules 100 are stacked and interconnected in the up-down direction. This modular integrated configuration is flexible and convenient, allowing for more adaptable modular arrangements and adjustments to suit different application scenarios.

Additionally, as shown in FIG. 6, by arranging the connections between the total positive terminals and total negative terminals of the four groups of battery modules 100, the power battery can be flexibly configured to exhibit single input/output or multiple input/output functions.

In connection with the above, the embodiments of the present disclosure also provide an assembly method of the battery module 100, as shown in FIG. 7. The method includes the following steps.

S101: providing a module housing 110 with an open top.

To assemble the battery module 100 according to the embodiment of the present disclosure, the following assembly methods and steps are adopted to effectively ensure assembly efficiency and assembly outcomes. First, the module housing 110 is provided, which is specifically arranged with an open top. The module housing 110 can be of a cuboid structure or any other required shape and structure. An opening is provided at the top portion of the module housing 110 to allow gradual assembly of a component structure, such as the battery cell group 120, from the open top into the module housing 110.

S102: arranging the rear-end plate 140 into the module housing 110, arranging at least two battery cell groups 120 in parallel into the module housing 110 through the open top, with one end surface of the at least two battery cell groups 120 fitting against the rear-end plate 140, wherein the battery cell groups 120 include multiple monomer battery cells 121 in an arrangement; inserting a front-end plate 130 between the other end surface of the at least two battery cell groups 120 and the module housing 110, to press and fix the at least two battery cell groups 120 in the module housing 110 along an arrangement direction of the monomer battery cells 121 of the battery cell groups 120;

A schematic view of the structure of the battery module 100 of FIG. 1 and an illustration of the orientation designation in the figure are referenced. First, the rear-end plate 140 is arranged at the rear portion of the module housing 110. Then, attached to the rear-end plate 140, the required number of monomer battery cells 121 are sequentially arranged. When two battery cell groups 120 are provided, as shown in FIG. 1, the monomer battery cells 121 of the two battery cell groups 120 can be arranged synchronously. Alternatively, it is also possible to arrange the required number of monomer battery cells 121 to one of the battery cell groups 120 at a time and arrange the required number of monomer battery cells 121 to another battery cell group 120. It should be noted that in some embodiments, it is necessary to pre-provide the bottom insulation plate 191 on the bottom plate 111 of the module housing 110 and adhere the two together using structural adhesive. After arranging structural adhesive to the surface of the bottom insulation plate 191, the battery cell groups 120 are then arranged. In this way, the arranged battery cell group 120 can also be adhered and fixed to the bottom insulation plate 191 and the bottom plate 111 of the module housing 110 through the structural adhesive.

After all the parallel-arranged battery cell groups 120 have been provided, the front-end plate 130 is inserted from the top to the bottom at the front end. As the front-end plate 130 is gradually inserted to reach the predetermined position, the structural adhesive enables the monomer battery cells 121 in the battery cell group 120 to have adhesive fixing force at the bottom. The pressing force provided by the pressing and insertion performed by the front-end plate 130 in the front-rear direction presses and fixes the monomer battery cells 121 in the battery cell groups 120.

S103: arranging a T-shaped heating plate 150 between the two adjacent battery cell groups 120, with a body portion 151 of the T-shaped heating plate 150 extending from the top to the bottom between the two battery cell groups 120, until two arms 152 of the T-shaped heating plate 150 are respectively snapped to shoulder portions of the two battery cell groups 120.

In the up-down direction, a T-shaped heating plate 150 is inserted between two adjacent battery cell groups 120. The body portion 151 of the T-shaped heating plate 150 extends from top to bottom between the two battery cell groups 120, until the two arms 152 of the T-shaped heating plate 150 are snapped onto the shoulder portions of the two battery cell groups 120, respectively. Inside the body portion 151, the heating wires 1513, which are coiled and evenly distributed between the body housing 1511 and the body cover plate 1512 and fixed by filling the structural adhesive, enable the uniform surface heating of all the monomer battery cells 121 of the two battery cell groups 120 on both sides of the T-shaped heating plate 150.

Moreover, the T-shaped heating plate 150 and the battery cell groups 120 can also be adhered and fixed together using structural adhesive, and at the same time, the extension fixing part 153 can be arranged in an extended manner at the end portions of the arms 152 to fix the module housing 110 in a threaded manner. The two arms 152 of the T-shaped heating plate 150 are respectively placed on the shoulder portions of the two adjacent battery cell groups 120 on the sides close to each other, and are pasted and fixed through structural adhesive. Thereby, the fixation of the shoulder portion on this side of the battery cell group 120 in the up-down direction is realized.

S104: arranging a fixing strip 180 on an outer shoulder portion of the battery cell group 120 located on a side of the module housing 110, wherein the fixing strip 180 is of an L-shaped structure; inserting one arm of the fixing strip 180 along an outer side edge of the battery cell group 120 between the outer side edge of the battery cell group 120 and the side of the module housing 110, until the other arm of the fixing strip 180 abuts the shoulder portion of the battery cell group 120 and is fixed with structural adhesive.

In the left-right direction, the fixing strip 180 is arranged on the outer shoulder portion of the battery cell group 120 located on a side, wherein the fixing strip 180 covers the shoulder portions of all monomer battery cells 121 in the battery cell groups 120 on the side, and the fixing strip 180 can adopt an L-shaped structure. One arm of the L-shaped structure is placed on the shoulder portion of the battery cell group 120. The other arm extends between the side plate 112 of the module housing 110 and the battery cell group 120.

In some embodiments of the present disclosure, before arranging the fixing strip 180, the side insulation plates 192 are first inserted between the side plate 112 on the left side of the module housing 110 and the battery cell group 120, and between the side plate 112 on the right side of the module housing 110 and the battery cell group 120, and the structural adhesive are filled for fix. The side insulation plates 192 on the left and right sides realize the insulating function for the two sides of the battery cell group 120. Moreover, the side insulation plates 192 can also eliminate gaps that could exist in the left and right directions within the module housing 110. Then, after arranging the fixing strips 180 on both sides, the other arm of the fixing strip 180 extends between the side plate 112 of the module housing 110 and the battery cell group 120 and abuts the side insulating plate 192. Alternatively, the other arm of the fixing strip 180 is opposite to the side insulating plate 192. The structural adhesive is filled between the fixing strip 180 and the battery cell group 120, and between the fixing strip 180 and the side plate 112 of the module housing 110, so that the remaining gap positions within the above space are sealed by filling with structural adhesive.

S105: assembling electrical components 160 at a top portion of the battery cell group 120 that is arranged with the T-shaped heating plate 150 and the fixing strip 180 and covering an upper cover plate 170, so as to fix the battery cell groups 120 in a vertical direction within the module housing 110, and closing the top portion of the module housing 110.

After the front-rear direction and the left-right direction have been stabilized and fixed, the electrical component 160 is assembled on the top portion of the battery cell group 120. After arranging the mica plate 161, the upper cover plate 170 presses and covers the top portion of the module housing 110, and the upper cover plate 170 is fixedly connected to the module housing 110 in the up-down direction using threaded fastening connecting pieces, thus completing the closure and fixation of the battery module 100.

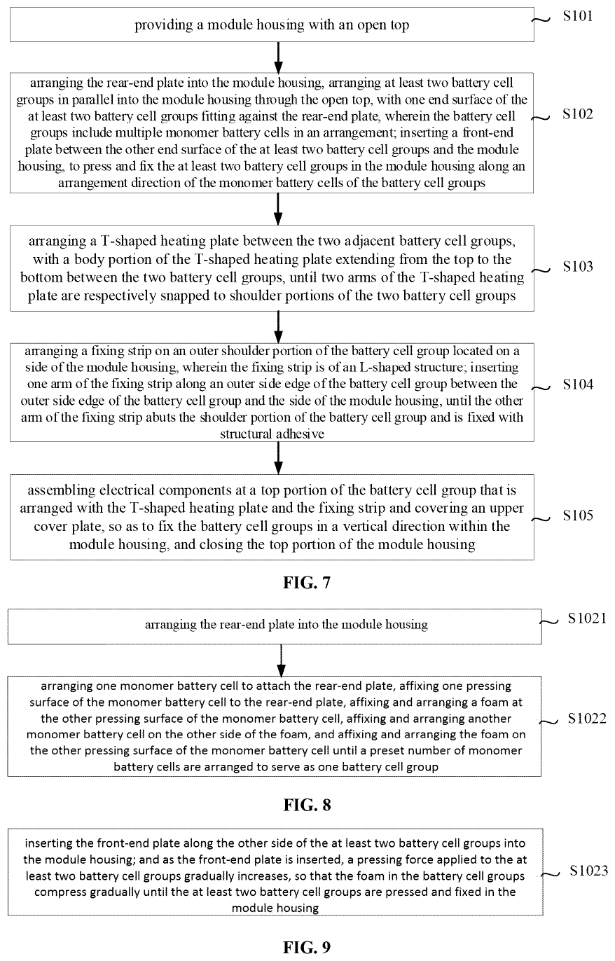

Optionally, as shown in FIG. 8, the S102 of arranging the rear-end plate 140 into the module housing 110, arranging at least two battery cell groups 120 in parallel into the module housing 110 through the open top includes the following steps.

S1021: arranging the rear-end plate 140 into the module housing 110.

When arranging at least two battery cell groups 120 in parallel in the front-rear direction, the following explanation will use one of the battery cell groups 120 as an example. When two battery cell groups 120 are arranged in parallel, the methods of arranging the two battery cell groups 120 are the same, and sequential or synchronized arrangement is also not limited in the present disclosure.

The rear-end plate 140 is first affixed to the side plate 112 on the rear side of the module housing 110 for arrangement and fixation.

S1022: arranging one monomer battery cell 121 to attach the rear-end plate 140, affixing one pressing surface of the monomer battery cell 121 to the rear-end plate 140, affixing and arranging the foam 122 at the other pressing surface of the monomer battery cell 121, affixing and arranging another monomer battery cell 121 on the other side of the foam 122, and affixing and arranging the foam 122 on the other pressing surface of the monomer battery cell 121, until a preset number of monomer battery cells 121 are arranged to serve as one battery cell group 120.

Then, affixed to the rear-end plate 140, one monomer battery cell 121 is arranged, and for each arrangement of a monomer battery cell 121, thereupon a piece of foam 122 is affixed and arranged to the other pressing surface of the monomer battery cell 121. Further, the next monomer battery cell 121 is arranged on the other pressing surface of the foam 122, and a piece of foam 122 is then affixed and arranged. After repeatedly and alternately affixing and arranging in this manner until the required number of monomer battery cells 121 are placed, the arrangement of this battery cell group 120 is completed. As the bottom insulation plate 191 is provided with a structural adhesive, the monomer battery cell 121 and the foam 122, which are affixed and arranged alternately, can be pasted and fixed to the bottom insulation plate 191.

The material properties of the foam 122 provide it with a certain compressive ability. Arranging foam 122 between two adjacent monomer battery cells 121 can be able to arrange the maximum number of monomer battery cells 121 as compactly as possible in the front-rear direction, which is the direction in which the battery cell groups 120 endure the pressing force. The compressive ability of the foam 122 can also absorb some of the pressing force in the front-rear direction, thereby protecting the monomer battery cells 121 in the battery cell group 120. This avoids excessive pressing force to harm the monomer battery cell 121, or friction or scratches between adjacent monomer battery cells 121.

Optionally, the front-end plate 130 satisfies that the thickness of the front-end plate 130 gradually increases along the direction of insertion into the module housing 110.

As shown in FIG. 9, the S102 of inserting a front-end plate 130 between the other end surface of the at least two battery cell groups 120 and the module housing 110, to press and fix the at least two battery cell groups 120 in the module housing 110 along an arrangement direction of the monomer battery cells 121 of the battery cell groups 120 includes the following step.

S1023: inserting the front-end plate 130 along the other side of at least two battery cell groups 120 into the module housing 110. As the front-end plate 130 is inserted, the pressing force applied to at least two battery cell groups 120 gradually increases, so that the foam 122 in the battery cell groups 120 compress gradually until at least two battery cell groups 120 are pressed and fixed in the module housing 110.

Reference can be made to FIG. 4, which shows that the section of the front-end plate 130 is wedge-shaped, and as it is inserted into the module housing 110 in the F direction, the thickness of the front-end plate 130 gradually increases. In other words, in the direction of the view in FIG. 4, the thickness of the upper end of the front-end plate 130 is greater than the thickness of the lower end.

Thus, during assembly, the front-end plate 130, as the last component inserted into the module housing 110 in the front-rear direction, is easier to insert due to its wedge-shaped structure. The front-end plate 130 is inserted along the other side of at least two battery cell groups 120 into the module housing 110. As the front-end plate 130 is inserted, due to its wedge-shaped design, the thickness of the front-end plate 130 gradually increases, so that the pressing force of the front-end plate 130 on the battery cell group 120 is also increased. The foam 122 within the battery cell groups 120 is gradually compressed, thereby fully releasing the dimensional space in the front-rear direction and gradually transferring the optimized pressing force to the monomer battery cells 121 within the battery cell groups 120 and maintaining it, until the front-end plate 130 is completely inserted into the module housing 110 to a predetermined position, thus achieving the required preload force required for the monomer battery cells 121 within the battery cell groups 120. In the process, the compression of the foam 122 and the protection for the monomer battery cells 121 are also fully utilized.

### Industrial Practicality

In summary, the embodiments of the present disclosure provide a battery module and an assembly method thereof, and a power battery. The battery module has the advantages of compact structure and size, stable fixing for the battery cells, uniform heating for the battery cells, and stable operation. Moreover, the modular design is more conducive to flexible adjustment to adapt to a variety of different practical scenarios, while simplifying and optimizing the assembly process.

The above are just specific embodiments of the present disclosure, but the scope of protection of the present disclosure is not limited to the embodiments. Any variations or substitutions readily apparent to those skilled in the art within the technical scope disclosed in the present disclosure should be encompassed within the scope of protection of the present disclosure.

What is claimed is:

1. A battery module, comprising: a module housing with an open top and at least two battery cell groups configured in the module housing, wherein the battery cell groups are arranged in parallel with each other, and at two end surfaces of the parallel-arranged battery cell groups, the battery cell groups are pressed and fixed in the module housing by a front-end plate and a rear-end plate; each battery cell group comprises multiple monomer battery cells in an arrangement; a T-shaped heating plate is arranged between two adjacent battery cell groups; a body portion of the T-shaped heating plate extends from top to bottom between the two battery cell groups; two arms of the T-shaped heating plate extend to shoulder portions of the two battery cell groups, respectively, and electrical components are assembled on top portions of at least two battery cell groups and are closed and fixed on a top portion of the module housing by an upper cover plate.

2. The battery module according to claim 1, wherein the module housing comprises a rectangular bottom plate and side plates that are connected to edges of the bottom plate and extend vertically, adjacent side plates are fixedly connected to each other, and a space enclosed by the bottom plate and the side plates is configured to accommodate and fix the at least two battery cell groups.

3. The battery module according to claim 1, wherein the T-shaped heating plate comprises the body portion and the two arms connected to one end of the body portion, the body portion comprises a body housing and a body cover plate which are capped with each other, and further comprises a heating wire arranged inside the body housing in a coiled manner, and the heating wire is led out through an end portion of the body housing, and is configured for power heating to ensure that the body portion heats evenly.

4. The battery module according to claim 3, wherein a holding groove is machined at a bottom of the body housing, and the holding groove has a semi-circular section and is configured for housing the heating wire.

5. The battery module according to claim 4, wherein a structural adhesive is filled between the body housing containing the heating wire and the body cover plate.

6. The battery module according to claim 1, wherein the T-shaped heating plate further comprises extension fixing parts at both ends, the extension fixing parts are located on the arms of the T-shaped heating plate, and on the extension fixing parts, and the T-shaped heating plate is fixedly connected to both ends of the module housing via bolts.

7. The battery module according to claim 1, wherein outer shoulder portions of battery cell groups located at edges of the at least two parallel-arranged battery cell groups are provided with fixing strips.

8. The battery module according to claim 7, wherein the fixing strips are L-shaped fixing strips, with one arm of the L-shaped fixing strip extending along the shoulder portion of the battery cell group and the other arm extending along an outer side edge of the battery cell group.

9. The battery module according to claim 7, wherein a structural adhesive is filled between the fixing strip and the battery cell group.

10. The battery module according to claim 1, wherein the battery cell group comprises multiple monomer battery cells, the monomer battery cell is provided with two opposite pressing surfaces and side surfaces between the two pressing surfaces, the pressing surfaces of multiple monomer battery cells are opposite to each other, and a foam is sandwiched between pressing surfaces of two adjacent monomer battery cells.

11. The battery module according to claim 10, wherein a thickness of the front-end plate gradually increases along an insertion direction toward the module housing, so that, after the battery cell groups are assembled into the module housing, a pressing force of the front-end plate on the pressing surfaces of the battery cell groups gradually increases as the front-end plate is inserted into the module housing.

12. The battery module according to claim 2, wherein a bottom insulation plate is provided on the bottom plate of the module housing, side insulation plates are respectively provided on inner sides of two opposite side plates of the module housing, the side insulation plates are located between side surfaces of the battery cell groups and the side plates of the module housing, and end insulation plates are provided between the front-end plate and the pressing surfaces of the monomer battery cells of the battery cell groups which are arranged on outside.

13. The battery module according to claim 12, wherein the bottom insulation plate is bonded and fixed to the bottom plate of the module housing.

14. The battery module according to claim 12, wherein a mica plate is provided between the electrical components and the upper cover plate.

15. The battery module according to claim 1, wherein the electrical components comprise a flexible printed circuit, a high-voltage connection structure, and a microcontroller unit; and the flexible printed circuit is electrically connected to the monomer battery cells in at least two battery cell groups via the high-voltage connection structure, with the high-voltage connection structure leading out a total positive terminal and a total negative terminal which are configured for external power supply.

16. A power battery, comprising one or more groups of the battery module according to claim 1.

17. The power battery according to claim 16, wherein when the power battery comprises at least two battery modules, the at least two battery modules are vertically stacked.

18. An assembly method of a battery module, wherein the method comprises providing a module housing with an open top;
arranging a rear-end plate into the module housing, arranging at least two battery cell groups in parallel into the module housing through the open top, with one end surface of the at least two battery cell groups fitting against the rear-end plate, wherein the battery cell groups comprise multiple monomer battery cells in an arrangement;
inserting a front-end plate between the other end surface of the at least two battery cell groups and the module housing, to press and fix the at least two battery cell groups in the module housing along an arrangement direction of the monomer battery cells of the battery cell groups;
arranging a T-shaped heating plate between two adjacent battery cell groups, with a body portion of the T-shaped heating plate extending from top to bottom between the two battery cell groups until two arms of the T-shaped heating plate are respectively snapped to shoulder portions of the two battery cell groups;
arranging a fixing strip on an outer shoulder portion of a battery cell group located on a side of the module housing, wherein the fixing strip is of an L-shaped structure;
inserting one arm of the fixing strip along an outer side edge of the battery cell group between the outer side edge of the battery cell group and the side of the module housing until the other arm of the fixing strip abuts the shoulder portion of the battery cell group and is fixed with a structural adhesive; and
assembling electrical components at a top portion of the battery cell group that is arranged with the T-shaped heating plate and the fixing strip and covering an upper cover plate, so as to fix the battery cell groups in a vertical direction within the module housing, and closing a top portion of the module housing.

19. The assembly method of the battery module according to claim 18, wherein the step of arranging a rear-end plate into the module housing, arranging at least two battery cell groups in parallel into the module housing within the open top comprises
arranging the rear-end plate into the module housing; and
arranging one monomer battery cell to attach the rear-end plate, affixing one pressing surface of the monomer battery cell to the rear-end plate, affixing and arranging a foam at the other pressing surface of the monomer battery cell, affixing and arranging another monomer battery cell on the other side of the foam, and affixing and arranging the foam on the other pressing surface of the monomer battery cell until a preset number of monomer battery cells are arranged to serve as one battery cell group.

20. The assembly method of the battery module according to claim 18, wherein a thickness of the front-end plate gradually increases along a direction of insertion into the module housing; and
the step of inserting a front-end plate between the other end surface of the at least two battery cell groups and the module housing, to press and fix the at least two battery cell groups in the module housing along an arrangement direction of the monomer battery cells of the battery cell groups comprises:
inserting the front-end plate along the other side of the at least two battery cell groups into the module housing; and as the front-end plate is inserted, a pressing force applied to the at least two battery cell groups gradually increases, so that the foam in the battery cell groups compress gradually until the at least two battery cell groups are pressed and fixed in the module housing.
